(19) United States
(12) Patent Application Publication
(10) Pub. No.: US 2008/0268830 A1
(43) Pub. Date: Oct. 30, 2008

(54) Proximity detection of coverage area boundary and display of mobile station location relative thereto

(76) Inventors: Ranjan Sharma, New Albany, OH (US); Shengqiang Wang, Cary, NC (US)

Correspondence Address: FAY SHARPE/LUCENT, 1100 SUPERIOR AVE, SEVENTH FLOOR, CLEVELAND, OH, 44114, US

(21) Appl. No.: 11/796,868

(22) Filed: Apr. 30, 2007

(51) Int. Cl. H04Q 7/20

(52) U.S. Cl. 455/421

(57) ABSTRACT

A method is provided for producing a user perceivable warning output by a mobile station (40) within a coverage area of a wireless telecommunications network (A) serving the mobile station (40) when the mobile station (40) is brought within a sufficient proximity to a boundary (82) defining an outer limit of the coverage area beyond which the mobile station (40) loses access to the wireless network (A). The method includes: obtaining a current position of the mobile station (40); storing a first map (80) on the mobile station (40), the first map (80) showing the coverage area of the wireless network in a vicinity around the current position of the mobile station (40) and indicating thereon a location of the boundary (82); comparing the current position of the mobile station (40) to the location of the boundary (82) on the stored first map (80) to determine a distance between the current position of the mobile station (40) and the boundary (82); and, triggering the warning in response to the determined distance being less than a first threshold value.

### FIELD

The present inventive subject matter relates to the telecommunication arts. Particular application is found in conjunction with certain types of telecommunication networks and/or facilities, and the specification makes particular reference thereto. However, it is to be appreciated that aspects of the present inventive subject matter are also amenable to other like applications, networks and/or facilities.

### BACKGROUND

Wireless networks (i.e., cellular and/or other like mobile networks) are generally known in the telecommunication arts. In a typical example, a mobile station (MS), e.g., such as a mobile or cellular telephone or other like end user device or terminal, is provided access to the wireless network via a radio frequency (RF) or other suitable over-the-air (OTA) interface. More specifically, a typical wireless network is generally comprised of a plurality of base stations that are capable of exchanging RF or other suitable signals and/or communications with a MS over a finite or limited range. Each base station (BS), therefore, serves a corresponding geographic area, e.g., which is commensurate in scope with the operative and/or effective range of the BS. The geographic area served by a BS is commonly known as a “cell.” As is generally known in the art, each BS provides the aforementioned RF or other OTA interface to the MS when the MS is located within the cell served by the particular BS.

Collectively, the combination of cells define the “coverage area” of the wireless network, i.e., the geographic area in which the MS is provided access to the wireless network. As can be appreciate, when the MS is located within the geographic boundaries of the coverage area (CA), it may selectively access the wireless network, e.g., via the RF or other OTA interface provided by the BS serving the cell in which the MS is located. Conversely, when the MS is outside the geographic boundaries of the CA, it is not able to access the wireless network insomuch as the MS is outside of any cell served by a BS of the wireless network—that is to say, the MS is out of range of any suitable network BS and therefore cannot utilize any corresponding RF or other OTA interface which would otherwise be provided by the BS.

As can be appreciated, a MS user may on occasion desire to know for their given location the status or availability of the wireless network serving their MS. Accordingly, many MS are provisioned with a signal strength monitor (SSM) or other like function or feature that is commonly known in the art. In a typical example, the SSM intermittently detects the signal strength for the RF or other OTA interface being provided by the wireless network at the current location of the MS. The signal strength, as is understood in the art, is generally related to the distance between the MS and BS that is serving the MS. Commonly, the detected or relative signal strength is in turn indicated to the user, e.g., via a message, meter or other icon output to a display on the MS. While generally effective to inform the user about the status or availability of the wireless network at the particular location of the MS, conventional SSMs and other like functions and/or features that are commonly known in the art have certain drawbacks and/or limitation which may be undesirable in certain circumstances.

For example, conventional SSMs are generally only informative if the MS is in range of the network or inside the CA. That is to say, if the MS is outside the CA or out of range of the wireless network, the SSM simply indicates zero or no signal or “network out of range” or some other similar indication. Assuming the MS user has traveled outside the CA of the wireless network serving their MS, then the foregoing information is of limited help to the user. More specifically, from the foregoing information alone, the user typically has no way of readily determining the direction and/or distance they should travel if they wish to return to the network CA, e.g., so as to obtain access the wireless network.

Additionally, conventional SSMs are not strictly informative with respect to preemptively notifying a user when they are approaching otherwise nearing a boundary of the CA and are consequently in jeopardy of losing access to the wireless network. Often times, a user may be unaware that the signal is lost or that they have traveled outside the CA or out of the network's range until after the fact, i.e., when the SSM fails to or no longer detects a signal. That is to say, only when the MS is outside the CA will the SSM indicate that no signal is being detected, but by the time this indication is output to the display it is too late to serve as a preemptive notification for the user insomuch as access to the wireless network has already been lost.

Alternately, when the SSM indicates a sufficiently low signal strength, the user may interpret this indication as meaning they are near a boundary of the CA. However, this information alone does not provide the user with any indication of the direction or sufficient indication of distance in which the boundary lies relative to the current location of the MS. Additionally, such an interpretation of a low signal strength is not strictly accurate. That is to say, a low signal strength can at times be detected well inside the boundaries of a wireless network's CA. Indeed, as is well known in the art, other factors can commonly contribute to the detection of a low signal strength. For example these factors may include: obstructions (e.g., natural or man-made) existing between the MS and serving BS; the MS may be located near the perimeter of neighboring cells but otherwise well within the overall CA of the wireless network; etc. As can be appreciated, in these instances, detection of a low signal strength is not strictly indicative of proximity to a CA boundary.

Accordingly, a new and improved method and/or feature for providing a mobile station positional information relative to a coverage area of a wireless network serving the mobile station is disclosed that overcomes the above-referenced problems and others.

### SUMMARY

In accordance with one embodiment, a method is provided for producing a user perceivable warning output by a mobile station within a coverage area of a wireless telecommunications network serving the mobile station when the mobile station is brought within a sufficient proximity to a boundary defining an outer limit of the coverage area beyond which the mobile station loses access to the wireless network. The method includes: obtaining a current position of the mobile station; storing a first map on the mobile station, the first map showing the coverage area of the wireless network in a vicinity around the current position of the mobile station and indicating thereon a location of the boundary; comparing the current position of the mobile station to the location of the boundary on the stored first map to determine a distance between the current position of the mobile station and the boundary; and, triggering the warning in response to the determined distance being less than a first threshold value.

In accordance with another embodiment, a mobile station is provided. The mobile station is served by a wireless telecommunications network having a coverage area defined by a boundary defining an outer limit of the coverage area beyond which the mobile station loses access to the wireless network. The mobile station includes: positioning means for obtaining a current position of the mobile station; storing means for storing a first map on the mobile station, the first map showing the coverage area of the wireless network in a vicinity around the current position of the mobile station and indicating thereon a location of the boundary; and, an application supported on the mobile station. The application is operative to: compare the current position of the mobile station to the location of the boundary on the stored first map to determine a distance between the current position of the mobile station and the boundary; and, trigger a user perceivable warning output by the mobile station in response to the determined distance being less than a first threshold value.

In accordance with another embodiment, a method is provided for guiding a user of a mobile station outside a coverage area of a wireless telecommunications network serving the mobile station to the coverage area. The coverage area is defined by a boundary beyond which the mobile station does not have access to the wireless network, and the method includes: obtaining a current position of the mobile station; storing a map on the mobile station, the map showing the coverage area of the wireless network in a vicinity around the current position of the mobile station and indicating thereon a location of the boundary; comparing the current position of the mobile station to the location of the boundary on the stored map to determine at least one of a distance and a direction to the boundary from the current position of the mobile station; and, outputting a user perceivable indication of at least one of the aforementioned distance and direction.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary wireless telecommunications network suitable for practicing aspects of the present inventive subject matter.

FIG. 2 is a graphical illustration of an exemplary mobile station suitable for practicing aspects of the present inventive subject matter.

FIG. 3 is a functional block diagram illustrating an exemplary mobile station suitable for practicing aspects of the present inventive subject matter.

FIG. 4 is a graphical illustration of an exemplary geo-map obtained in accordance with the practicing of aspects of the present inventive subject matter.

FIG. 5 is a graphical illustration of an exemplary CA-map obtained in accordance with the practicing of aspects of the present inventive subject matter.

FIG. 6 is a graphical illustration of an exemplary output displayed in accordance with the practicing of aspects of the present inventive subject matter.

FIG. 7 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

With reference to FIG. 1, a wireless telecommunications network A includes a mobile switching center (MSC) 20 that may optionally be operatively connected to and/or in communication with a public switched telephone network (PSTN) and/or data network (e.g., such as the Internet or other like network) 10 in the usual manner. Suitably, the MSC 20 is also operatively connected to and/or in communication with a plurality of base stations 30 in the usual manner. As is understood in the art, each BS 30 provides an RF or other suitable OTA interface 34 for its respective geographic area or cell 32. Selectively, a MS 40 (e.g., in the form of a mobile telephone or any other suitable wireless end user terminal) is provided telecommunication services and/or otherwise accesses the network A via the interface 34 and/or BS 30 serving the cell 32 in which the MS 40 is located.

While only one MSC is illustrated in FIG. 1 for purposes of simplification and clarity, it is to be appreciated that the network A may in fact include any number of one or more MSCs that are similarly situated and/or arranged. Additionally, while three BS 30 and three corresponding cells 32 are illustrated in FIG. 1, it is to be appreciated that more or less than three base stations and/or cells may be similarly situated with respect to any of the one or more MSCs in the network A. That is to say, each MSC in the network A may optionally serve any number of one or more base stations and/or corresponding cells. Additionally, while only one exemplary MS is illustrated in FIG. 1, the network A optionally serves any number of one or more mobile stations similarly situated and/or arranged in any of the one or more cells 32.

More specifically, the wireless network A is generally comprised of a plurality of base stations 30 that are capable of exchanging RF or other suitable signals and/or communications with the MS 40 over a finite or limited range. Each BS 30, therefore, serves a corresponding geographic area, e.g., which is commensurate in scope with the operative and/or effective range of the BS 30. The geographic area served by each BS 30 is referred as a cell 32. Each BS 30, therefore, provides the aforementioned interface 34 to the MS 40 when the MS 40 is located within the cell 32 served by the particular BS 30.

Collectively, the combination of cells 32 define the CA of the wireless network A, i.e., the geographic area in which the MS 40 is provided access to the wireless network A. When the MS 40 is located within the geographic boundaries of the CA, the MS 40 may selectively access the wireless network A, e.g., via the interface 34 provided by the BS 30 serving the cell 32 in which the MS 40 is located. Conversely, when the MS 40 is outside the geographic boundaries of the CA, it is not able access the wireless network A insomuch as the MS 40 is outside of any cell 32 served by a BS 30 of the wireless network A—that is to say, the MS 40 is out of range of any suitable network BS 30 and therefore cannot utilize any corresponding interface 34 which would otherwise be provided by the BS 30.

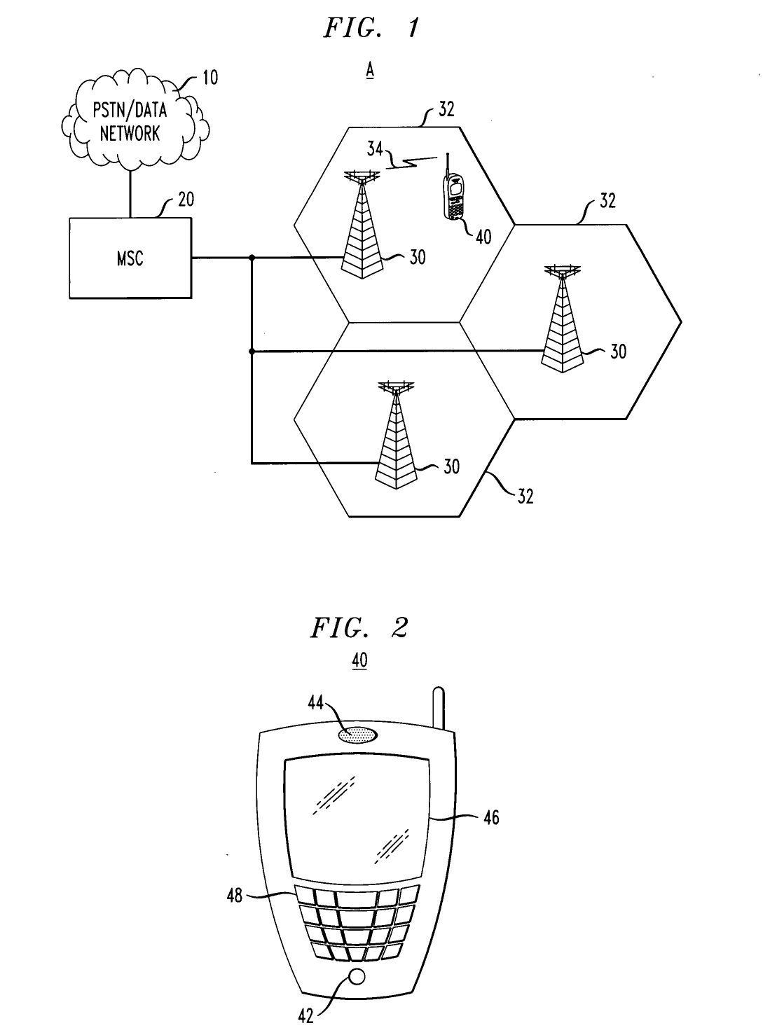

Suitably, the MS 40 is optionally provisioned with the usual components and/or elements, e.g., a central processing unit (CPU) and/or operating system that controls and regulates operation of the MS 40; a keypad with traditional numeric buttons, a number of soft and/or hard buttons, navigation buttons, etc.; a liquid crystal display (LCD), touch sensitive screen, or other suitable display; a graphical user interface (GUI); a memory or other data storage device; and, other components commonly found on and/or incorporated in an MS. As shown in FIG. 2, an input/output (I/O) interface is employed for user interaction with and/or operation of the MS 40. Suitably, the interface includes: a microphone 42, a speaker 44 or other audio transducer, a display 46 and a keypad 48, as is typical for a MS.

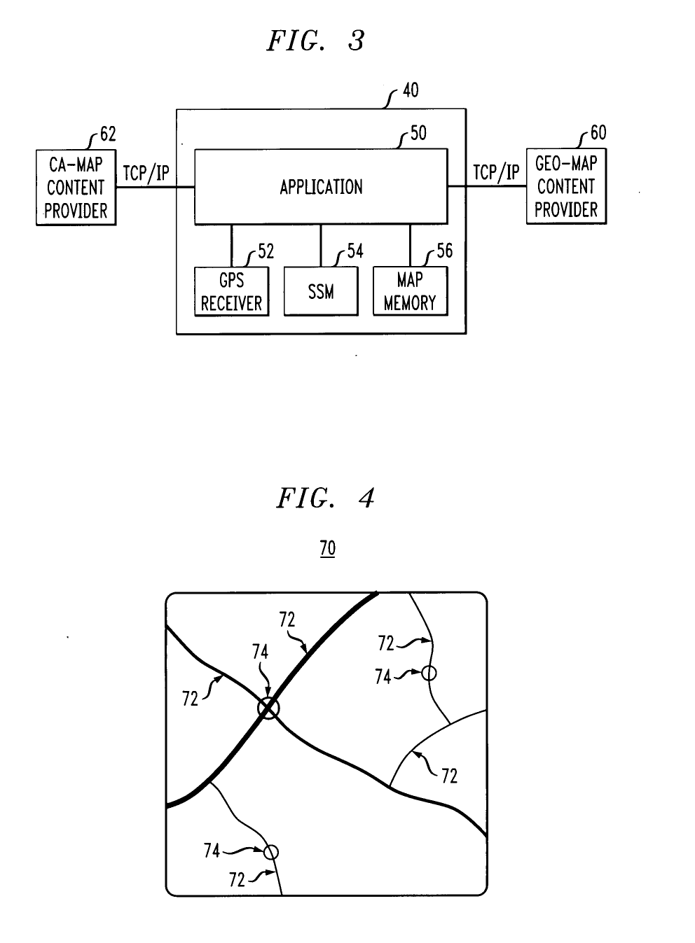

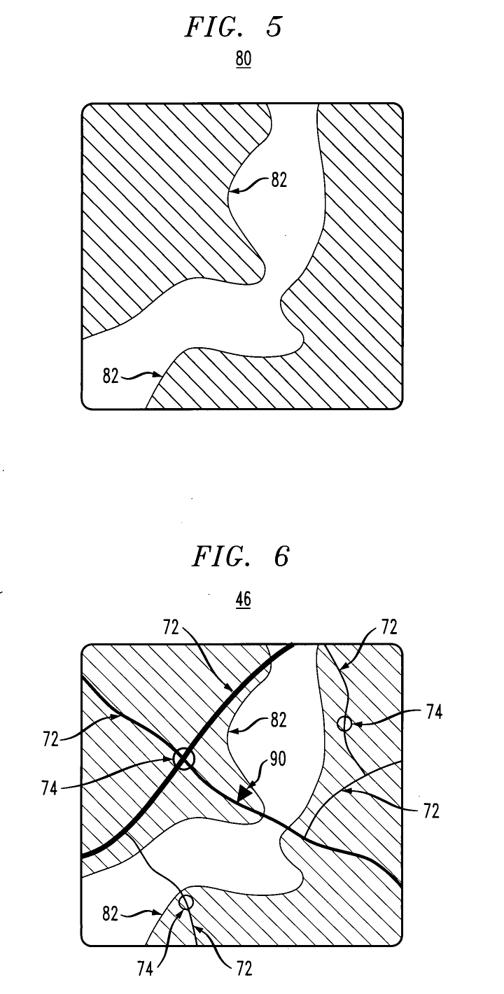

With reference to FIG. 3, the MS 40 is equipped and/or otherwise provisioned with a function, program, software or other suitable application 50 that is supported and/or runs on or is otherwise selectively executed by the MS 40. In general, the application 50 is operative as further described herein to selectively obtain: a location of the MS 40; a geographic map (referred to herein nominally as a geo-map) of the vicinity surrounding the MS's location (e.g., such as the example geo-map 70 illustrated in FIG. 4); and, a map of the CA for the wireless network A serving the MS 40 (referred to herein nominally as a CA-map) in the vicinity surrounding the MS's location (e.g., such as the example CA-map 80 illustrated in FIG. 5). In turn, the application 50 is also operative as further described herein to output to the display 46 the obtained geo-map superimposed with the obtained CA-map and indicating relatively thereon the obtained position of the MS 40 (e.g., as illustrated in FIG. 6). Suitably, the application 50 is triggered or otherwise activated to automatically provide the aforementioned output and/or other warning or notifications upon detection of one or more determined conditions. Alternately or in addition, the aforementioned output is optionally provided on demand in response to an input user request or other suitable manual operation.

As further illustrated in FIG. 3, the MS 40 is also provisioned with a geo-positioning subsystem. For example, the MS 40 is optionally equipped with a global positioning system (GPS) receiver 52 or other like device that operates in the usual manner to determine the geo-location of the MS 40 which in turn is selectively obtained by the application 50. In the illustrated embodiment, the MS 40 is further equipped and/or otherwise provisioned with a SSM 54 and a map memory 56. The SSM 54 is optionally implemented in any customary fashion to periodically or intermittently detect the signal strength (SS) of the wireless network A at the location of the MS 40. Suitably, an appropriate application program interface (API) is provided to aid the application 50 in obtaining information or data generated by the SSM 54 regarding network availability and/or SS. Accordingly, via the API, the application 50 selectively obtains the SS measurements taken by the SSM 54, e.g., as a relative value compared to a maximum SS or a percentage of the maximum SS.

In the illustrated embodiment, the map memory 56 stores geo- and CA-maps (e.g., such as the maps 70 and 80 illustrated in FIGS. 4 and 5, respectively) that are selectively downloaded to the MS 40 and/or otherwise obtained by the application 50 from one or more map providers or servers. As shown in FIG. 4, the geo-map 70 is supplied by a first map provider or server 60 and the CA-map 80 is supplied by a second map provider or server 62. However, alternately, the maps may be provided or otherwise supplied and/or downloaded from the same provider or server. Optionally, the maps are stored separately in the map memory 56, or alternately, the application 50 registers the maps with one another and stores them together in the map memory 56 with the CA-map 80 superimposed over the geo-map 70.

In practice, suitably, the CA-map server 62 is operated or maintained by the wireless network service provider or a proxy thereof, and it contains a complete map of the entire CA for the wireless network A. Accordingly, the CA-map server 62 can be readily updated to reflected changes in the CA as such changes are experienced from time to time. Suitably (e.g., as best seen in FIG. 5), the map maintained by the provider and/or on the server 62 depicts or otherwise indicates CA boundaries 82, and shows areas inside the CA being distinguished from area outside the CA via suitable shading, cross-hatching or other distinctive highlighting. It is to be appreciated that the CA-map 80 which is generated by the provider/server 62 and supplied to the MS 40 is typically only a portion of the entire or full version map which is maintained by the provider and/or on the server 62, namely, that portion which is relevant to and/or in the vicinity of the current location of the MS 40. Nevertheless, the data and/or information included in the supplied CA-map 80 reflects the same or substantially the same data and/or information included in the respective portion of the entire or full version map maintained by the provider and/or on the server 62.

The geo-map server 60 is optionally operated or maintained by a suitable third party or a proxy thereof, and it contains a full version and/or entire map for a selected or otherwise determined geographic region. Accordingly, the geo-map server 60 can be readily updated to reflect certain geographic changes as such changes are experienced and/or noted by the third party from time to time. Suitably (e.g., as best seen in FIG. 4), the map maintained by the provider and/or on the server 60 depicts or otherwise indicates the relative location of certain man-made and/or natural geographic landmarks, e.g., such as highways or roads 72, municipalities dr cites 74, bodies of water, state or county or other territorial subdivision lines, points-of-interest, etc. Again, it is to be appreciated that the geo-map 70 which is generated by the provider/server 60 and supplied to the MS 40 is typically only a portion of the entire or full version map which is maintained by the provider and/or on the server 60, namely, that portion which is relevant to and/or in the vicinity of the current location of the MS 40. Nevertheless, the data and/or information included in the supplied geo-map 70 reflects the same or substantially the same data and/or information included in the respective portion of the entire or full version map maintained by the provider and/or on the server 60.

Suitably, to download the respective geo- and CA-maps, the MS 40 (e.g., at the request and/or under the direction of the application 50) establishes a connection with the respective provider(s) or server(s). For example, a TCP/IP (Transmission Control Protocol/Internet Protocol) or other suitable connection is optionally established over the data network 10 which is accessed by the MS 40 via the wireless network A. To define the geo- and CA-maps requested by the application 50, the application 50 provides a set of parameters over the established connection to the map provider(s)/server(s). Responsive to the supplied parameters, the map provider(s)/server(s) generate the appropriate maps which is in turn are downloaded or otherwise delivered to the MS 40 and stored in the map memory 56. Suitably, the set of parameters provided by the application 50 include: the current location of the MS 40 (e.g., as obtained by the application 50 from the GPS receiver 52); and, a determined scale and/or size of the map (e.g., 20 miles by 20 miles or some other suitable value) which can optionally be selectively configurable and/or adaptable as desired for the particular circumstances. Using the supplied parameters, the map provider(s)/server(s) in turn generate the corresponding maps at the appropriate scale and/or size, e.g., suitably centered or substantially centered about the provided location of the MS 40. Having generated the requested geo- and CA-maps, they are in turn downloaded or otherwise delivered to the MS 40 for storage in the map memory 56.

In an alternate embodiment, e.g., where the MS 40 has a sufficiently large on-board memory capacity, entire maps of the CA and/or geographic region (e.g., similar to the versions which would otherwise be maintained by the providers 60 and/or 62) are pre-stored locally on the MS 40. Such an embodiment, relieves the network A and the MS 40 of the burden of having to periodically and/or intermittently download the respective geo- and/or CA-maps from remote provider(s)/server(s) each time they are requested or otherwise wanted by the application 50. Instead, the requested or desired geo- and/or CA-maps are generated locally from the full versions stored on the MS 40 in response to the set of map defining parameters established by the application 50. Of course, however, this will tend to increase the relative processing demands on the MS 40 with respect to the generation of the maps. That is to say, the MS 40 will now be responsible for scaling, sizing and/or centering defined maps requested by and/or suitable for the application 50. Additionally, the locally pre-stored full versions of the maps will not be as readily updateable by the respective content providers insomuch as they are not maintained on their own servers 60 and 62. Accordingly, the local pre-stored full versions of the maps may tend to be out-of-date at any given time. However, new full versions of the maps may still optionally be downloaded from the servers 60 and/or 62 to the MS 40 from time-to-time to replace or up-date older out-of-date maps. Still, it may be desirable to limit the frequency of such up-dates as the downloading of the larger full version maps will tend consume relatively more bandwidth and/or otherwise burden the network 10 and/or the MS 40.

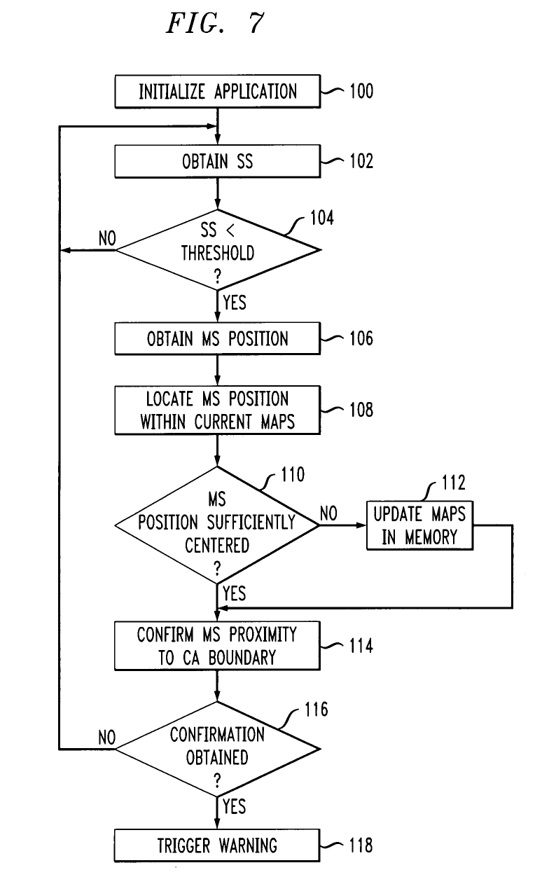

With reference now to FIG. 7, the illustrated flow chart shows an exemplary process by which the application 50 operates. While the steps in the illustrated flow chart are arranged and/or described in a particular order for the purposes of simplicity and clarity herein, it is to be appreciated that certain steps and/or portions thereof may alternately be executed in other suitable orders. Additionally, where appropriate, some steps and/or portions thereof may in practice be executed in parallel with one another, i.e., concurrently or at substantially the same time.

For example, the process may in practice begin with steps 102 and 104—the establishment of the initial maps and/or the initial position of the MS 40 as described with respect to step 100 optionally following sometime thereafter. In fact, step 106 may optionally fulfill the role of establishing the initial MS location. Such an arrangement, for example, would tend to relieve the MS 40 of the burden of performing the later functions if indeed a suitably strong signal were detected by the SSM 54, thereby indicating that the MS 40 was sufficiently close to as BS 30 and consequently not in eminent danger of leaving the CA and/or losing access to the network A.

Notwithstanding the foregoing stipulation and/or example, as illustrated, the process begins at step 100 with the initialization of the application 50. Optionally, the application 50 is started automatically upon powering up of the MS 40. Alternately, the application 50 is manually or otherwise started by the user. Advantageously, by providing a manual start and/or shut-off for the application 50, the user can opt to forego running the application when it is not desired (e.g., during routine travel, when in familiar surroundings, etc.), and thereby conserve the battery life and/or other resources of the MS 40. Additionally, network bandwidth and/or other network resources are also conserved if the application 50 is not made to run when its function is not desired by the user.

Optionally, when the application 50 is started, it obtains an initial position of the MS 40, e.g., from the GPS receiver 52. Additionally, at start-up, presuming the MS 40 is within the CA of and/or otherwise has access to the network A, the application 50 also optionally obtains initial geo- and CA-maps showing the vicinity about the current MS location (e.g., such as maps 70 and 80). More specifically, for example, the MS 40 establishes a TCP/IP or other suitable connection with the servers 60 and 62 over the data network 10 which is accessed by the MS 40 via the wireless network A. The application 50 then provides the set of map defining parameters (i.e., the current location of the MS 40 and the selected scale and/or map size) over the established connection to the servers 60 and 62. Responsive to the supplied parameters, the servers 60 and 62 generate the appropriate geo- and CA-maps which is in turn are downloaded or otherwise delivered to the MS 40 and stored in the map memory 56. That is to say, using the supplied parameters, the servers 60 and 62 generate the corresponding maps at the appropriate scale and/or size, e.g., suitably centered or substantially centered about the provided location of the MS 40, and having generated the requested geo- and CA-maps, they are in turn downloaded or otherwise delivered to the MS 40 for storage in the map memory 56.

At step 102, the application obtains the SS, e.g., from the SSM 54 via a suitable API. At decision step 104, the obtained SS is compared by the application 50 to a set or otherwise determined threshold level (e.g., 20% of the maximum SS or some other desirable level which is optionally selectively configurable or otherwise adaptable as desired for the particular circumstances at hand). If it is determined that the obtained SS is not below the threshold, then the process loops back to step 102 where it awaits the start of the next iteration of the monitoring cycle. Suitably, the monitoring cycle periodically repeats itself at a set or otherwise determined time interval, e.g., every 30 seconds or some other desirable interval which is optionally also selectively configurable or otherwise adaptable as desired for the particular circumstances at hand. Optionally, the application 50 monitors the amount of movement or speed of the MS 40 and in response thereto adjusts the monitoring interval or cycle accordingly. For example, when MS 40 is moving relatively more or moving relatively fast, the monitoring interval or cycle is shortened, and alternately, when MS 40 is moving relatively little or moving relatively slow or is essentially stationary, the monitoring interval or cycle is lengthened. Suitably, the amount of movement of the MS 40 and/or speed of the MS 40 is determined from and/or by comparing two or more successive or otherwise time differentiated positions of the MS 40, e.g., as measured by the GPS receiver 52.

Otherwise, if it is determined that the obtained SS is below the threshold, then the process continues to step 106. At step 106, the current position of the MS 40 is obtained. For example, the application 50 suitably obtains the current position of the MS 40 from the GPS receiver 52. In this manner, the application 50 accounts for any movement of the MS 40 since its position was previously obtained.

At step 108, the application 50 locates the relative position of the MS 40 within the most recently obtained geo- and/or CA-maps. That is to say, the application determines the current position of the MS 40 relative to the most recently obtained geo- and/or CA-maps. More specifically, for example, the MS position obtained in step 106 is compared to the maps obtained by the application 50 from the map memory 56.

Suitably, at decision step 110, the application 50 determines if the current MS position is sufficiently centered in the most recently obtained geo- and/or CA-maps, e.g., which are stored in the map memory 56. For example, the application 50 optionally calculates or otherwise determines the difference in distance between the center of the maps and the current position of the MS 40. Accordingly, if the difference is within a set or otherwise determined threshold (e.g., 0.5 miles or some other desirable amount which is optionally selectively configurable or otherwise adaptable as desired for the particular circumstances at hand), then the MS position is deemed to be sufficiently centered with respect to the most recently obtained geo- and/or CA-maps, otherwise if the difference exceeds the threshold, then the MS position is deemed not to be sufficiently centered with respect to the most recently obtained geo- and/or CA-maps. In this manner, the application 50 ensures that the most recently obtained geo- and/or CA-maps (e.g., contained in the map memory 56) are relatively up-to-date and/or provide an acceptable view of the vicinity surrounding the current location of the MS 40 in all directions. For example, if the current location of the MS 40 is too close to one edge of the most recently obtained geo- and/or CA-maps because the MS 40 has traveled too far in that direction since the maps were last stored in the memory 56, then the vicinity of the MS in the direction of that edge may not be adequately displayed or viewable on the map—that is to say, the maps are relatively out-of-date in light of the significant movement of the MS 40. Alternately, if the current location of the MS 40 remains near the center of the most recently obtained geo- and/or CA-maps because the MS 40 has not traveled significantly far in any one direction since the maps were last stored in the memory 56, then the vicinity surrounding the MS in all directions may be adequately displayed or viewable on the map—that is to say, the maps are relatively up-to-date in light of the insignificant movement of the MS 40.

Therefore, if at decision step 110 the application 50 determines that the current MS position (e.g., obtained in step 106) is not sufficiently centered within the most recently obtained geo- and/or CA-maps (e.g., obtained from the map memory 56), then before proceeding to step 114, the process branches to step 112 wherein the geo- and CA-maps in the map memory 56 are updated (e.g., by obtaining new geo- and CA-maps in a manner the same as or similar to the one described above with respect to the initial geo- and/or CA-maps). Otherwise, if at decision step 110 the application 50 determines that the current MS position is sufficiently centered within the geo- and/or CA-maps already contained in the map memory 56, then the process bypasses the unwarranted step 112 of updating the maps and continues directly to step 114.

As discussed above in the background, certain factors other than proximity to a CA boundary, may cause a low SS to be detected by the SSM 54. Accordingly, optional steps 114 and 116 are provided in order to avoid a false determination and/or indication of CA boundary proximity by the application 50 based solely upon the detection of a low SS by the SSM 54.

Suitably, at step 114, the application 50 optionally confirms that the current location of the MS 40 is approaching or is sufficiently proximate to a CA boundary. For example, the application 50 locates the relative position of the MS 40 within the most recently obtained CA-map. That is to say, the application 50 determines the current position of the MS 40 relative to the most recently obtained CA-map (e.g., stored in the memory 56). More specifically, the MS position obtained by the application 50 in step 106 is optionally compared to the CA-map obtained by the application 50 from the map memory 56. Based thereon, the application 50 measures, calculates or otherwise determines the distance between the current MS position and the nearest point of any CA boundary 82 contained on the current CA-map. If the distance is less than a set or otherwise determined threshold (e.g., which is optionally selectively configurable or otherwise adaptable as desired for the particular circumstances at hand), then the proximity of the MS 40 to the boundary 82 has been confirmed or otherwise substantiated by the application 50, otherwise if the distance is greater than the threshold, then the proximity of the MS 40 to a CA boundary is not confirmed or otherwise not substantiated by the application 50. Consequently, if at decision step 116, the application 50 has determined that the current position of the MS 40 is not sufficiently proximate to a CA boundary, then the process loops back to step 102 where it awaits the start of the next iteration of the monitoring cycle and thereby avoids what would have been an otherwise unwarranted execution of step 118 in connection with the current iteration of the monitoring cycle. Otherwise, if at decision step 116, the application 50 has determined that the current position of the MS 40 is sufficiently proximate to a CA boundary, then the process indeed continues to step 118 as is rightfully warranted.

At step 118, the application 50 triggers and/or otherwise directs the MS 40 to output a preemptive CA boundary proximity warning so as to be perceivable by the MS user. Suitably, upon the triggering of the warning, the geo- and CA-maps currently stored in the memory 56 are automatically output on the display 46 with the CA-map superimposed over the geo-map and the current location of the MS 40 reflected or otherwise indicated in its relative position thereon (e.g., by a flag, icon, symbol or other position marker 90) as shown in FIG. 6. Optionally, a measurement of the distance and/or the direction to the CA boundary being approached by or in closest proximity to the MS 40 is also output on the display 46. For example, this information is optionally already generated or otherwise obtained by the application 50 in connection with the execution of step 114 of the above-described process. Suitably, using the keypad 48 and/or other suitable controls provided on the MS 40, the user may selectively chose to zoom in and/or out on the output map(s) to view greater or less detail therein, or the user may selectively chose to pan or scroll in selected directions across the output maps(s) to view desired regions thereof. Additionally, the warning is also optionally accompanied by an audible signal emitted from the speaker 44 and/or a vibration of the MS 40 aimed at attracting the user's attention to the MS 40.

Suitably, as can be appreciated from the present description, the application 50 provides an early warning and/or preemptive notification function or capability to the MS 40. That is to say, current geo- and CA-maps are downloaded to the MS 40 (e.g., in steps 100 and/or 112 of the above-described process) while the MS 40 is still located inside the CA such that access the wireless network A remains available, and the MS user is in turn alerted to the close proximity of the MS 40 to a CA boundary prior to the MS 40 leaving the CA and/or losing access to the wireless network A. Accordingly, the MS user is afforded the opportunity to take any desired corrective action before they leave the CA thereby losing access to the wireless network A. For example, guided by the output on the display 46 the user may chose to alter their travel route in order to remain in the CA of the wireless network A or may chose to make any desired calls or otherwise access the network A before leaving the CA of the network A.

Furthermore, the application 50 also provides the MS 40 with a tool that the user can selectively employ to readily reacquire access to the wireless network A even after they have left the CA and/or lost access to the network A. In particular, being that the most recently obtained geo- and CA-maps (which were previously downloaded while the MS 40 was still in the CA and/or had access to the network 10) are stored locally in the memory 56 of the MS 40, they are in essence persistent (i.e., they remain available to the application 50) even after the MS 40 has left the CA and/or lost access to the network A. Additionally, insomuch as the GPS receiver 52 does not rely on the availability of access to the network 10 in order to determine the location of the MS 40, the application 50 optionally keeps on periodically or intermittently obtaining the current position of the MS 40 even when the MS 40 is outside of the network's CA. Accordingly, the application 50 continues to update the position of the MS 40 such that the current location of the MS 40 is accurately reflected in the output on the display 46 relative to the persistent local maps obtained from the memory 56 of the MS 40. If the MS user therefore wishes to reacquire access to the network 10, they may view or otherwise employ the output on the display 46 to readily guide themselves along the most expedient or an otherwise desired route back into the CA of the wireless network 10. In one exemplary embodiment, by using the keypad 48 and/or other suitable controls provided on the MS 40 to select a designated automatic guidance function, the user may optionally obtain (either from the application 50 or from another suitably provisioned application supported on the MS 40) driving, turn-by-turn or other suitable directions or instructions for returning from the current MS position to the nearest or another selected point within the CA of the wireless network A.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for producing a user perceivable warning output by a mobile station within a coverage area of a wireless telecommunications network serving the mobile station when the mobile station is brought within a sufficient proximity to a boundary defining an outer limit of the coverage area beyond which the mobile station loses access to the wireless network, said method comprising:
(a) obtaining a current position of the mobile station;
(b) storing a first map on the mobile station, said first map showing the coverage area of the wireless network in a vicinity around the current position of the mobile station and indicating thereon a location of the boundary;
(c) comparing the current position of the mobile station to the location of the boundary on the stored first map to determine a distance between the current position of the mobile station and the boundary; and,
(d) triggering the warning in response to the determined distance being less than a first threshold value.

2. The method of claim 1, wherein step (a) comprises:
determining the current position of the mobile station based upon a received output from a global position system receiver incorporated in the mobile station.

3. The method of claim 1, wherein the method further comprises:
(e) intermittently updating the current position of the mobile station by repeating step (a).

4. The method of claim 3, wherein the method further comprises:
(f) determining a difference between the current position of the mobile station and a center of the first map; and,
(g) prior to step (c), updating the stored first map in response to the determined difference being greater than a second threshold value, such that the stored first map is substantially centered on the current position of the mobile station.

5. The method of claim 1, wherein the method further comprises:
(e) monitoring a strength of a signal transmitted on an over-the-air interface provided between the mobile station and the wireless network; and,
(f) in response to the signal strength dropping below a second threshold value, executing steps (a) through (d), otherwise skipping steps (a) through (d).

6. The method of claim 1, wherein the method further comprises:
(e) storing a second map on the mobile station, said second map showing geographical landmarks in the vicinity around the current position of the mobile station, said geographical landmarks including roads.

7. The method of claim 6, wherein step (d) comprises:
outputting the first and second maps to a display of the mobile station such that the first map is superimposed over the second map; and,
providing a marker on the output maps that indicates the current position of the mobile station relative thereto.

8. The method of claim 7, wherein the method further comprises:
(e) intermittently updating the current position of the mobile station by repeating step (a); and,
(f) correspondingly updating a location of the marker on the output maps to reflected the updated current position of the mobile station.

9. The method of claim 7, wherein the steps (e) and (f) continue to be executed even when the mobile station travels outside the coverage area.

10. The method of claim 7, wherein step (d) further comprises:
emitting an audible signal from a speaker of the mobile station.

11. The method of claim 1, wherein the steps (d) is executed prior to the mobile station exiting the coverage area.

12. A mobile station served by a wireless telecommunications network having a coverage area defined by a boundary defining an outer limit of the coverage area beyond which the mobile station loses access to the wireless network, said mobile station comprising:
positioning means for obtaining a current position of the mobile station;
storing means for storing a first map on the mobile station, said first map showing the coverage area of the wireless network in a vicinity around the current position of the mobile station and indicating thereon a location of the boundary; and,
an application supported on the mobile station, said application being operative to:
compare the current position of the mobile station to the location of the boundary on the stored first map to determine a distance between the current position of the mobile station and the boundary; and,
trigger a user perceivable warning output by the mobile station in response to the determined distance being less than a first threshold value.

13. The mobile station of claim 12, wherein the positioning means comprises a global position system receiver that intermittently updates the current position of the mobile station.

14. The mobile station of claim 13, wherein said application is further operative to:
determine a difference between the current position of the mobile station and a center of the first map; and,
update the first map stored in the storing means in response to the determined difference being greater than a second threshold value, such that the first map stored in the storing means is substantially centered on the current position of the mobile station.

15. The mobile station of claim 12, further comprising:
a signal strength monitor for monitoring a strength of a signal transmitted on an over-the-air interface provided between the mobile station and the wireless network; and,
wherein, in response to the signal strength dropping below a second threshold value, the application is activated, otherwise the application is deactivated.

16. The mobile station of claim 12, wherein the storing means further stores a second map on the mobile station, said second map showing geographical landmarks in the vicinity around the current position of the mobile station, said geographical landmarks including roads.

17. The mobile station of claim 16, said mobile station further comprising:
a display on which the first and second maps are output such that the first map is superimposed over the second map, said display further showing a marker on the output maps that indicates the current position of the mobile station relative thereto.

18. The mobile station of claim 12, further comprising:
a speaker, said speaking emitting an audible signal in response to the application triggering the warning.

19. The mobile station of claim 12, wherein the application triggers the warning prior to the mobile station exiting the coverage area.

20. A method for providing a user of a mobile station outside a coverage area of a wireless telecommunications network serving the mobile station guidance to the coverage area, said coverage area being defined by a boundary beyond which the mobile station does not have access to the wireless network, said method comprising:
(a) obtaining a current position of the mobile station;
(b) storing a map on the mobile station, said map showing the coverage area of the wireless network in a vicinity around the current position of the mobile station and indicating thereon a location of the boundary;
(c) comparing the current position of the mobile station to the location of the boundary on the stored map to determine at least one of a distance and a direction to the boundary from the current position of the mobile station; and,
(d) outputting a user perceivable indication of at least one of the distance and direction from step (c).
